(19) United States
(12) Patent Application Publication
(10) Pub. No.: US 2005/0013962 A1
(43) Pub. Date: Jan. 20, 2005

(54) Thermoplastic polymer material for audio and/or optical information recording media

(76) Inventors: Yannick Ederle, Billere (FR); Gilles Meunier, Mazerolles (FR); Pierre Gerard, Denguin (FR)

Correspondence Address: Thomas F Roland;Atofina Chemicals, 2000 Market Street, 26th Floor, Philadelphia, PA, 19103, US

(21) Appl. No.: 10/494,192

(22) PCT Filed: Oct. 30, 2002
(86) PCT No.: PCT/FR02/03751

(30) Foreign Application Priority Data
Oct. 31, 2001 (FR) 01/14134

(51) Int. Cl. B32B 3/02

(52) U.S. Cl. 428/64.2; 428/64.1

(57) ABSTRACT

The invention concerns moulded discs for audio and/or optical information recording media (such as CDS and DVDs) obtained from a thermoplastic polymer material comprising, by weight, (a) 60 to 95%, preferably 70 to 85%, of a thermoplastic resin selected from (1) a methyl methacrylate homopolymer, (2) a copolymer containing in majority units derived from methyl methacrylate monomer, (3) a mixture of the homopolymer (1) and/or of the copolymer (2) with a substituted or unsubstituted styrene copolymer and of at least one monomer selected from (meth)acrylonitrile, maleic anhydride and maleimides or (4) a glutarimide polymer, optionally mixed with a substituted or unsubstituted styrene/(meth)acrylonitrile copolymer and (b) 5 to 40%, preferably 15 to 30%, of at least one impact modifier compound in the form of particles having an average size of between 10 and 200 nm, preferably between 40 and 150 nm.

This application claims benefit, under U.S.C. §119 or §365 of FrenchApplication Number 01/14134, filed Oct. 31, 2001; and PCT/FR02/03751 filed Oct. 30, 2002.

### FIELD OF THE INVENTION

The invention relates to moulded discs for audio and/or optical information recording media, in particular audio discs (CDs) and DVDs (Digital Versatile Discs or Digital Video Discs), and to a polymer thermoplastic material useful for manufacturing them.

### BACKGROUND OF THE INVENTION

Within the context of the invention, the term “thermoplastic polymer material” is understood to mean particularly a material based on a thermoplastic methacrylic (co)polymer resin, that is to say a methyl methacrylate homopolymer or a copolymer containing predominantly units derived from the methyl methacrylate monomer or else resulting from chemical modification of the methacrylic (co)polymer, for example by imidation.

Methyl methacrylate homopolymers and methacrylic copolymers containing predominantly methyl methacrylate units are thermoplastic polymers increasingly used because of their exceptional optical properties (gloss and very high transparency, with at least 90% light transmission in the visible), their ageing resistance, their corrosion resistance and their resistance to atmospheric agents. Furthermore, these polymers and copolymers, hereafter called (co)polymers, have a certain advantage for moulded discs useful for manufacturing audio and/or optical information recording media because, on the one hand, of their low birefringence (low double refraction index) and, on the other hand, of their high melt flow index which makes it possible, in particular, to obtain discs by conventional injection-moulding techniques or by injection-compression moulding, and precise duplication of the “pits” (cavities of small geometrical dimensions) of the dies.

These thermoplastic methacrylic (co)polymers, because they are brittle, are liable to break during the various phases of their conversion and during their transportation and their use. In particular, it has been noted that moulded discs for audio and/or optical information recording media obtained from these polymers may have cracks that form from the centre of the discs while they are being manufactured and handled during this manufacture and during their use, in particular when packing them in cases.

It is known to add impact modifier compounds in order to improve the impact strength of these methacrylic (co)polymers. However, although the crack resistance is considerably improved, the results are still not satisfactory since it is no longer possible to obtain correct duplication of the pits.

In the present invention, the aim is therefore to seek thermoplastic-polymer-based materials that allow the manufacture of moulded discs for audio and/or optical information recording media that are crack-resistant, while preserving the properties necessary for this type of product, especially the ability of correctly duplicating the pits, without forgetting transparency and birefringence.

### SUMMARY OF THE INVENTION

It is therefore an object of the present invention firstly to provide moulded discs for audio and/or optical information recording media, obtained from a thermoplastic polymer material comprising, by weight:

(a) 60 to 95%, preferably 70 to 85%, of a thermoplastic resin chosen from:
(1) a methyl methacrylate homopolymer,
(2) a copolymer containing predominantly units derived from the methyl methacrylate monomer,
(3) a blend of the homopolymer (1) and/or of the copolymer (2) with a copolymer of a substituted or unsubstituted styrene with at least one monomer chosen from (meth)acrylonitrile, maleic anhydride and maleimides or
(4) a glutarimide polymer, optionally blended with a substituted or unsubstituted styrene/(meth)acrylonitrile copolymer; and

(b) 5 to 40%, preferably 15 to 30%, of at least one impact modifier compound in the form of particles having an average size of between 10 and 200 nm, preferably between 40 and 150 nm.

### BRIEF DESCRIPTION OF THE DRAWINGS

FIG. 1 is a diagram showing a test piece, produced from the thermoplastic polymer material, to be subjected to a tensile test according to Test 1 described below measuring the crack resistance of the said test piece. In this diagram, the test piece is shown in the form of a rectangle of width “L”. Midway along the test piece there are two notches “a”. The distance between the ends of these two notches is equal to L−2a and corresponds to the length of the “ligament” to be broken.

FIG. 2 is a diagram of a set-up for measuring the crack resistance of a disc according to Test 2 described below. Shown in this diagram are a disc (1) whose crack resistance it is desired to measure, a punch (2) provided with two fins (3) making an angle of 30° with the vertical direction of the punch, this punch having an end in the form of a ball (4) with a diameter of 14 mm. This punch is placed near the centre of the disc for the purpose of its impacting this part of the disc.

FIGS. 3 to 5 show a view using atomic force microscopy of the replication of pits on DVD discs obtained in Examples 1 and 2 (controls) and Example 3 (according to the invention).

### DETAILED DESCRIPTION OF THE INVENTION

The thermoplastic resin (a) may be formed from methyl methacrylate homopolymer (1) and/or from a copolymer (2) containing predominantly units derived from the methyl methacrylate monomer. These (co)polymers (1) and (2) comprise from 51 to 100%, preferably from 80 to 99%, by weight of methyl methacrylate units and from 0 to 49%, preferably 1 to 20%, by weight of units derived from monoethylenically unsaturated comonomers copolymerizable with methyl methacrylate.

To form the copolymer (2), the methyl methacrylate monomer may be polymerized with one or more comonomers. The monoethylenically unsaturated comonomer(s) copolymerizable with the methyl methacrylate monomer is (are) especially chosen from acrylic, methacrylic, maleimide, maleic anhydride and styrene monomers.

As acrylic monomers, mention may be made of alkyl acrylates in which the alkyl group has from 1 to 10 carbon atoms (such as methyl acrylate, ethyl acrylate and n-butyl, 2-ethylhexyl and isobutyl acrylate), hydroxyalkyl or alkoxyalkyl acrylates, in which the alkyl group has from 1 to 4 carbon atoms, acrylamide and acrylonitrile.

As methacrylic monomers, mention may be made of alkyl methacrylates in which the alkyl group has from 2 to 10 carbon atoms (such as ethyl, isobutyl, secondary butyl and tertiary butyl methacrylate), isobornyl methacrylate, methacrylonitrile and hydroxyalkyl or alkoxyalkyl methacrylates in which the alkyl group has from 1 to 4 carbon atoms.

As maleimide monomers, mention may be made of N-cyclohexylmaleimide and N-isopropylmaleimide.

The thermoplastic resin (9) may also be formed from a blend (3) comprising, by weight, 60 to 97%, preferably 70 to 95%, of a methyl methacrylate homopolymer (1) and/or of a copolymer (2) containing predominantly units derived from the methyl methacrylate monomer, and 3 to 40%, preferably 5 to 30%, of a substituted or unsubstituted styrene/(meth)acrylonitrile copolymer and/or of a substituted or unsubstituted styrene/maleic anhydride copolymer (SMA) and/or of a substituted or unsubstituted styrene/maleimide copolymer.

The substituted or unsubstituted styrene/(meth)acrylonitrile copolymer is advantageously formed, by weight, from 8 to 35% of (meth)acrylonitrile and from 65 to 92% of substituted or unsubstituted styrene.

The substituted or unsubstituted styrene/maleic anhydride copolymer (SMA) is advantageously formed, by weight, from 8 to 33% of maleic anhydride and from 67 to 92% of substituted or unsubstituted styrene.

The substituted or unsubstituted styrene/maleimide copolymer, that can be used in the invention, is advantageously formed, by weight, from 8 to 21% of maleimides and from 72 to 92% of substituted or unsubstituted stryene. As maleimides, mention may be made of N-cyclohexylmaleimide and N-isopropylmaleimide.

As substituted styrene for these copolymers, it is possible to use alpha-methylstyrene, monochlorostyrene and tert-butylstyrene monomers.

The thermoplastic resin (9) may also consist of a glutarimide polymer (4) comprising imide units of formula: 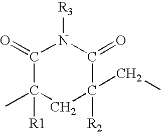
in which the symbols R₁, R₂ and R₃ are identical or different and may be hydrogen or a substituted or unsubstituted alkyl, aryl, alkaryl or aralkyl group having from 1 to 20 carbon atoms. The substituents may be chosen from halogen atoms and methyl, ethyl, hydroxyl, methoxy, ethoxy, carboxyl and ethylcarbonyl groups. The degree of imidation is at least 40%.

These glutarimide polymers that can be used in the invention are described, for example, in patent U.S. Pat. No. 4,954,574 and the document EP-A-515 095.

It is also possible to use, as thermoplastic resin (a), a polymer blend, like that described in the document EP-A-515 095, which comprises a copolymer having glutarimide groups and a styrene or substituted styrene/(meth)acrylonitrile copolymer. The blend may comprise, by weight, from 40 to 85% of glutarimide polymer, and from 15 to 60% of (meth)acrylonitrile.

It is advantageous to use, as thermoplastic resin (a), a copolymer (2) containing predominantly units derived from the methyl methacrylate monomer. Particularly advantageous is a methyl methacrylate/alkyl acrylate copolymer in which the alkyl group has from 1 to 4 carbon atoms, the amount of alkyl acrylate representing up to 6%, preferably from 0.5 to 5%, and more particularly from 0.1 to 3%, by weight of the polymer. Such copolymers are described in the documents WO 98/57799 and WO 99/65671.

The thermoplastic resin (a) generally has a weight-average molecular mass (M_{w}), measured by steric exclusion chromotography using methyl methacrylate homopolymer standards for the calibration, of between 50,000 and 200,000 g/mol, preferably between 60,000 and 140,000 g/mol.

In accordance with the invention, the thermoplastic polymer material used to manufacture the moulded discs for audio and/or optical information recording media furthermore includes at least one impact modifier compound (also called impact modifier) whose average size is between 10 and 200 nm, preferably between 40 and 150 nm and in particular between 80 and 120 nm.

These “impact modifiers” are products based on elastomeric materials. These impact modifiers are generally polymer substances having a multilayer structure, at least one of the layers consisting of an elastomer phase. Given that it is the elastomer phase contained in the additive that gives the impact strength, this additive is added to the brittle thermoplastic in order to have a suitable proportion of the elastomer.

The impact modifier compound useful within the invention may consist of a block copolymer comprising at least one elastomer block resulting from the polymerization of monomers such as butadiene, substituted or otherwise, alkyl acrylates or aralkyl acrylates. This may in particular be a diblock copolymer such as poly(butadiene-block-methyl methacrylate) or a triblock copolymer such as poly(styrene-block-butadiene-block-methyl methacrylate), in which copolymers the polybutadiene elastomer phase represents up to about 50% by weight of the mass of the block copolymer. The butadiene block may be unhydrogenated, partially hydrogenated or completely hydrogenated. This may also be a poly(methyl methacrylate-block-butyl acrylate-block-methyl methacrylate), copolyether esteramides having polyamide and polyether blocks, and copolymers having polyester and polyether blocks.

The impact modifier compound may also be a polymer substance having a multilayer structure, at least one of the layers consisting of an elastomer phase. These polymer substances may thus be particles obtained by coagulation, drying, spraying or atomization of an elastomer latex. The manufacture of such latices, used for increasing the impact strength of thermoplastic matrices, is well known to those skilled in the art. In particular, it is known that by modifying the conditions under which these latices are manufactured, it is possible to vary their morphology and consequently their ability to improve the impact strength and their ability to maintain the optical properties of the matrix to be reinforced.

The various elastomer latex morphologies known at the present time will be able to be used without any problem within the context of the present invention. In particular, it will be possible to use a latex with a “soft-hard” morphology, the first phase (or core) of which is an elastomer and the “hard” final phase (or external layer) of which is a brittle thermoplastic. These latices may be obtained in two steps, for example, in a first step, by the emulsion polymerization, in an aqueous medium in the presence of an initiator generating free radicals and of an emulsifier, of at least one monomer (called a “soft” monomer, that is to say a monomer resulting in a polymer having a glass transition temperature below 25° C.) that has to constitute the elastomer phase, chosen for example from monomers such as butadiene, substituted or otherwise, and alkyl or aralkyl acrylates in which the alkyl group has from 1 to 15 carbon atoms and, in a second step, by again the emulsion polymerization, in the presence of the polymer of the first step, of at least one monomer that has to constitute a “hard” phase compatible with the brittle thermoplastic polymer (the matrix) of which it is desired to improve the impact strength. This or these monomers (called “hard” monomers, that is to say monomers resulting in a polymer having a glass transition temperature greater than or equal to 25° C.) may be chosen, for example, from alkyl methacrylates in which the alkyl group contains from 1 to 4 carbon atoms, vinylaromatic monomers such as styrene and substituted styrenes, and acrylonitrile and methacrylonitrile monomers. The “hard” phase may also be obtained from a mixture of the above hard monomers (in a predominant amount) and of one or more ethylenically unsaturated comonomers, such as a lower alkyl acrylate or (meth)acrylic acid.

Optionally, the polymerization of the monomers not constituting the “hard” final phase may be carried out in the presence of other ethylenically unsaturated polyfunctional monomers copolymerizable with the former monomers, particularly crosslinking and/or grafting monomers. The polymer constituting the final “hard” phase may be formed in the presence of a crosslinking monomer. As well-known crosslinking monomers that can be used, mention may be made of polyol polyacrylates and polymethacrylates, such as alkylene glycol diacrylates and dimethacrylates; as grafting monomers that can be used, mention may be made of allyl esters, such as allyl acrylate and methacrylate.

Thus, as disclosed in FR-A-2 092 389, the elastomer phase may be prepared from a mixture comprising, by weight, at least 50% of an alkyl or aralkyl acrylate, in which the alkyl group has from 1 to 15 carbon atoms, 0.05 to 5.0% of a crosslinking monomer, 0.05 to 5% of grafting monomers and 0 to 10% of a hydrophilic monomer (such as (meth)acrylic acid, hydroxylated alkyl esters of methacrylic acid and amides), the balance optionally consisting of other ethylenically unsaturated copolymerizable monomers (such as styrene); the final brittle thermoplastic phase, polymerized in the presence of the elastomer phase, may be obtained from a monomer mixture comprising at least 50% by weight of an alkyl methacrylate, the elastomer phase and the thermoplastic phase having a minimum degree of chemical attachment of about 20%.

It will also be possible to use a latex with a “hard-soft-hard” morphology, the non-elastomer first phase (or core) of which is polymerized from the monomers that may form the methacrylic (co)polymer material to be reinforced (a) or the abovementioned “hard” final phase, the intermediate phase of which is an elastomer obtained, for example, from the abovementioned so-called “soft” monomers and the final phase of which is formed from monomers that can be used for the methacrylic (co)polymer material (a) or the abovementioned “hard” final phase. Particularly suitable is a latex like that described in U.S. Pat. No. 3,793,402, which latex is formed (1) from a non-elastomer core consisting of a copolymer obtained from 80 to 100% by weight of at least one so-called “hard” monomer, such as an alkyl methacrylate (the alkyl being C₁-C₄), styrene, (meth)acrylonitrile optionally combined (at 0-30% by weight) with one or more ethylenically unsaturated comonomers, such as a lower alkyl (meth)acrylate (the alkyl being C₁-C₄) and (meth)acrylic acid, 0 to 10% by weight of a polyfunctional crosslinking monomer and 0 to 10% by weight of a grafting monomer, such as those mentioned above, (2) from an elastomer intermediate layer, formed in the presence of the polymer (1) from 50 to 99.9% by weight of one or more butadiene monomers, substituted or otherwise, and/or an alkyl acrylate in which the alkyl group has from 1 to 8 carbon atoms, from 0 to 49.9% by weight of one or more ethylenically unsaturated comonomers, such as lower alkyl (meth)acrylates (the alkyl being C₁-C₄), (meth)acrylic acid and styrene, from 0 to 5% by weight of a polyfunctional crosslinking monomer and from 0.05 to 5% by weight of a grafting monomer, such as those mentioned above and (3) from a so-called “hard” or compatibilizing external layer formed, in the presence of the polymers (1) and (2), from “hard” monomers (C₁-C₄ alkyl methacrylate, styrene or (meth)acrylonitrile) optionally combined (at 0-30% by weight) with ethylenically unsaturated comonomers, such as a lower alkyl (meth)acrylate (the alkyl being C₁-C₄). In particular, the various phases—core (1), intermediate layer (2) and external layer (3)—represent, respectively, 10 to 40%, 20 to 60% and 10 to 70% by weight of the total mass of the trilayer (or triphase) composite copolymer.

It is also possible to use a product with a soft/hard/soft/hard morphology, as disclosed in the document EP-B-270865, which comprises (1) a central core based on a crosslinked elastomer intimately blended with a thermoplastic methacrylic (co)polymer resin, (2) an optional first layer of the said resin grafted onto the central core, (3) a second layer of crosslinked elastomer grafted onto the said first layer or onto the said core and (4) a third resin layer grafted onto the said crosslinked elastomer second layer.

Other morphologies that could be used are those more complex ones disclosed in the patents U.S. Pat. No. 4,052,525 and FR-A-2 446 296.

The impact modifier compound (b) used in the invention is advantageously in the form of a multilayer composite copolymer.

The thermoplastic polymer material may optionally contain standard additives, such as lubricants and UV stabilizers, in an amount from 0% to 1% by weight in relation to the total weight of the material.

The thermoplastic polymer material is advantageously in the form of granules allowing moulded discs according to the invention to be manufactured by injection moulding or injection-compression moulding.

The thermoplastic resin (a), when it is formed by a methacrylic (co)polymer, may be obtained by any known process, for example by suspension or mass polymerization. It may be in the form of granules or beads. The beads are obtained by the well-known process of aqueous suspension polymerization of one or more monomers in the presence of an initiator soluble in the monomer(s) and of a suspension agent. The granules may be obtained from these beads, which are melted in an extruder to form rods; the latter are then cut into granules. The granules may also be prepared by mass polymerization, a well-known process, consisting in polymerizing the monomer(s) or else a prepolymer syrup dissolved in the monomer(s) in the presence of an initiator. The polymer obtained is forced, at the end of the line, through a die in order to obtain rods, that are then cut into granules. For the preparation of beads and granules, it is also possible to add a chain transfer agent to control the molar mass of the polymer, and optionally other useful additives.

The thermoplastic polymer material used according to the invention may be obtained by melt-blending the granules and/or beads of thermoplastic resin (a), particularly methacrylic (co)polymers, of at least one impact modifier compound (b), usually in powder form, and optionally of other additives, such as lubricants and UV stabilizers. This blend may be produced in any suitable device, for example an extruder, generally at a temperature of around 220° C. The blend is then in the form of granules, which can be used to manufacture discs moulded by injection-compression moulding.

The moulded discs according to the invention may be obtained by any known process, and in particular by injection moulding or injection-compression moulding of the granules in an injection-moulding machine at a temperature of at least 250° C., as described in Application WO 98/57799.

It is also an object of the present invention to provide moulded discs suitable as audio and/or optical information recording media (such as DVDs), comprising at least one moulded disc as described above.

DVD discs are typically obtained by joining together, by means of an adhesive, a first moulded disc metallized by sputtering and a second, optionally metallized, moulded disc.

It is also an object of the present invention to provide a novel thermoplastic polymer material that is useful in particular for the manufacture of moulded discs for information recording media, the said material being as defined above, and furthermore characterized in that it comprises, by weight:

(a) from 70 to 85% of a thermoplastic resin chosen from:
(1) a methyl methacrylate homopolymer,
(2) a methyl methacrylate/alkyl acrylate copolymer in which the alkyl group has from 1 to 4 carbon atoms, the amount of alkyl acrylate representing from 0.1 to 3% of the copolymer,
(3) a blend of the homopolymer (1) and/or of the copolymer (2) with a copolymer of a substituted or unsubstituted styrene with at least one monomer chosen from (meth)acrylonitrile, maleic anhydride and maleimides or
(4) a glutarimide polymer, optionally blended with a substituted or unsubstituted styrene/(meth)acrylonitrile copolymer; and

(b) from 15 to 30% of at least one impact modifier compound in the form of particles having an average size of between 10 and 200 nm, preferably between 40 and 150 nm.

The following examples illustrate the invention.

### EXAMPLES

The crack resistance was determined by the following tests:

1. Test on the test pieces (Test 1):

Granules of thermoplastic polymer material obtained by melt-blending thermoplastic resin granules (a) with an impact modifier (b) were heated in an oven for 4 h at 70° C. They were then extruded in the form of a strip using a FAIREX-type single-screw extruder, with no venting ports, fitted with an appropriate flat die. The strips, 35 mm in width and 0.6 mm in thickness (E), were then cooled by a non-thermostatted calender.

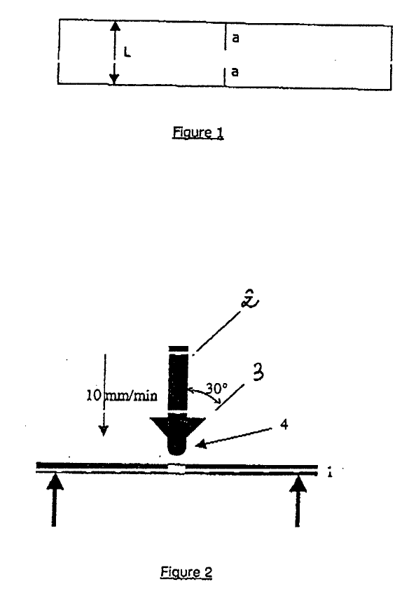

Specimens 90 mm in length were taken from the various strips produced (the dimensions of each specimen were 90 mm×35 mm×0.6 mm). Test pieces for undergoing a tensile test were thus prepared, as in FIG. 1, with a length of 90 mm and a width “L” of 35 mm, the thickness (E) being 0.6 mm.

Notching:

The notch the test piece, two tapered notches “a” facing each other (see FIG. 1) were machined at mid-length of the test piece. The crack length “a” of the test pieces, ready to be tested, must lie within the limits given by 0.45 L/2≦a≦0.55 L/2. The distance (L−2a) represents the length of the “ligament” to be broken.

Next, a natural crack is produced by pressing lightly on a fresh razor blade in the notches by means of a micrometer screw. The increase in length of the crack thus obtained (0.1 mm) was more than four times the original radius of the tip of the notch.

Conditioning:

The test piece was then conditioned for 24 hours (at 23° C. and 50% relative humidity).

Test machine and set-up:

The mechanical tests were carried out on a ADHAMEL DY30 test machine from MTS. During the tensile test, the test piece was held by means of two clamping jaws.

Test conditions:

The tests were carried out at 23° C. and at a test speed of 10 mm/min. A minimum of five tests were carried out on each material.

Determination of the crack resistance:

The fracture toughness (or toughness) G was calculated using the following equation, that is to say from the work W (performed until the moment when the crack propagates in the absence of additional stress) divided by the surface area of the broken ligament:
G=W/(E(L−2a)) expressed in kJ/m²
   where:
W is the work performed (the area under the force-displacement curve);
E is the thickness of the test piece; and
(L−2a) is the length of the broken ligament.

2) Test on DVD discs (Test 2)

The crack resistance, measured on the DVD discs, was measured using an MTS 831 test machine from MTS according to the principle shown in FIG. 2.

Test machine and set-up:

In the cracking test, the disc (1), with a diameter of 108 mm, was held between four diametrically opposed bearing points (not shown in the diagram) and was stressed at its centre by means of the punch (2).

Test conditions:

The tests were carried out at 23° C. and at a test speed of 10 mm/min. A minimum of five tests were carried out on each material.

Determination of the crack resistance:

The crack resistance was calculated from the work W performed to the moment when a crack propagates, in the absence of additional stress, from the centre of the disc. W, expressed in mJ, represents the work performed (the area under the force-displacement curve).

### EXAMPLE 1

### Control

Granules of the methyl methacrylate (97 wt %)/ethyl acrylate (3 wt %) copolymer having a weight-average molar mass of 75,000 g/mol were used. These granules were extruded as a strip 35 mm in width and 0.6 mm in thickness using a FAIREX-type single-screw extruder fitted with a suitable flat die. Specimens 90 mm in length were taken from the strip. The refractive index was 1.49.

The fracture toughness (G) was determined according to the abovementioned Test 1 cracking test. It was 1.71±0.26 kJ/m².

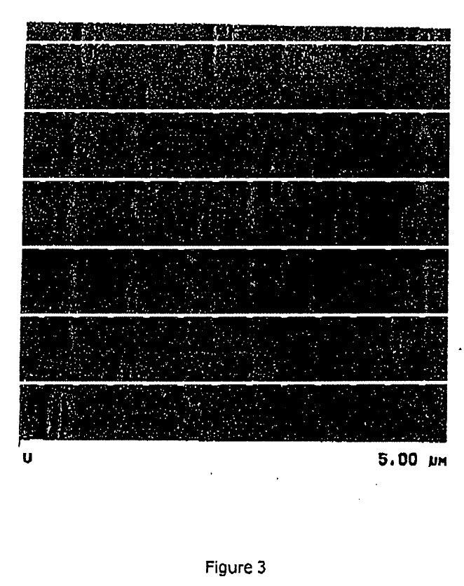

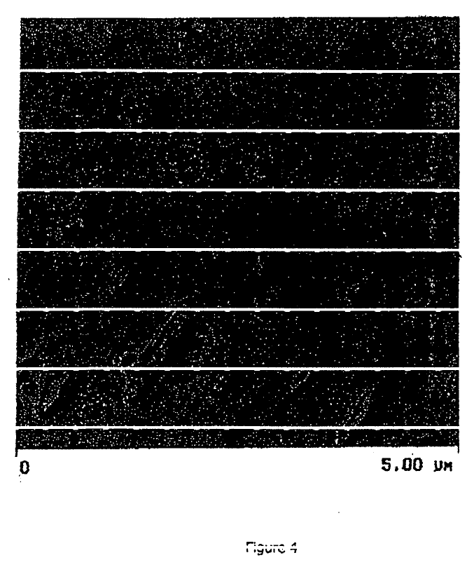

Next, these granules were injection-moulded on a video disc (DVD) manufacturing line from Singulus. The thickness of the DVD was 1.2 mm. The crack resistance, measured after Test 2 (DVD crack resistance test), was 14 mJ±3. Replication of the pits was checked by atomic force microscopy. The replication was excellent (see FIG. 3).

### EXAMPLE 2

### Control

77 parts by weight of granules of a methyl methacrylate/ethyl acrylate (97/3 wt %) copolymer having a weight-average molar mass of 75,000 g/mol and 23 parts by weight of the impact modifier in powder form given below were extrusion-blended at a temperature of about 220° C. in an 11D Buss co-kneader fitted with a weigh feeder.

This impact modifier was in the form of three-layer granules having the composition described in Example 2 of U.S. Pat. No. 3,793,402, that is to say:
a core formed from a methyl methacrylate (99.8%)/allyl methacrylate (0.2%) copolymer;
an interlayer formed from a butyl acrylate (79.4%)/styrene (18.6%)/allyl methacrylate (0.2%) copolymer; and
an outer layer formed from a methyl methacrylate (96%)/ethyl acrylate (4%) copolymer;
   the distribution, by weight, from the core, of the interlayer and the outer layer being 30%, 50% and 20% respectively.

The average size of the impact modifier powder particles was 300 nm. The refractive index was 1.49.

The granules obtained were extruded as a strip as in Example.

The fracture toughness G was determined according to the abovementioned Test 1 cracking test. It was 20.13±4.35 kJ/m².

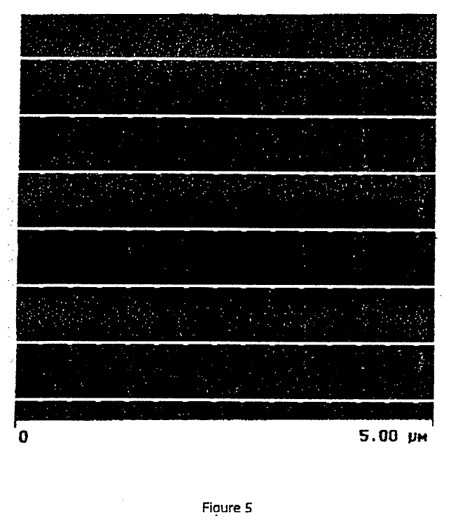

Next, these granules were injection-moulded on a video disc (DVD) manufacturing line from Singulus. The thickness of the DVD was 1.2 mm. The crack resistance, measured after. Test 2 (DVD crack resistance), was 108 mJ±15. Replication of the pits was checked by atomic force microscopy. Replication was very bad (see FIG. 4).

### EXAMPLE 3

### According to the Invention

80 parts by weight of granules of a methyl methacrylate/ethyl acrylate (97/3 wt %) copolymer having a weight-average molar mass of 75,000 g/mol and 20 parts by weight of the impact modifier in powder form were extruder-blended at a temperature of about 220° C. in an 11D Buss co-kneader fitted with a weigh feeder.

The impact modifier was a two-layer compound: soft core (70 wt %)/hard shell (30 wt %) in which the core consisted of a butyl acrylate (48 wt %)/butadiene (52 wt %) copolymer and the shell consisted of a methyl methacrylate (96 wt %)/ethyl acrylate (4 wt %) copolymer. The average size was 100 nm. The refractive index was 1.49.

The granules obtained were extruded as a strip as in Example 1.

The fracture toughness G was determined according to the abovementioned Test 1 cracking test. It was 57.10±6.48 kJ/m².

Next, these granules were injection-moulded on a video disc (DVD) manufacturing line from Singulus. The thickness of the DVD was 1.2 mm. The crack resistance, measured after Test 2 (DVD crack resistance), was 945 mJ±140. Replication of the pits was checked by atomic force microscopy. Replication was excellent (see FIG. 5).

1-17. cancel

18. Moulded discs for audio and/or optical information recording media, obtained from a thermoplastic polymer material comprising, by weight:
(a) 60 to 95%. of a thermoplastic resin chosen from:
(1) a methyl methacrylate homopolymer,
(2) a copolymer containing predominantly units derived from the methyl methacrylate monomer,
(3) a blend of the homopolymer (1) and/or of the copolymer (2) with a copolymer of a substituted or unsubstituted styrene with at least one monomer chosen from (meth)acrylonitrile, maleic anhydride and maleimides or
(4) a glutarimide polymer, optionally blended with a substituted or unsubstituted styrene/(meth)acrylonitrile copolymer; and
(b) 5 to 40%, of at least one impact modifier compound in the form of particles having an average size of between 10 and 200 nm, preferably between 40 and 150 nm.

19. Moulded discs according to claim 18 comprising by weight 70 to 85% of said thermoplastic resin.

20. Moulded discs according to claim 18 comprising by weight 15 to 30%, of at least one impact modifier compound in the form of particles.

21. Moulded discs according to claim 18, characterized in that the copolymer (2) containing predominantly units derived from the methyl methacrylate monomer is formed from 51 to 100%, by weight of methyl methacrylate units and from 0 to 49%, by weight of units derived from monoethylenically unsaturated comonomers copolymerizable with methyl methacrylate.

22. Moulded discs according to claim 21 characterized in that the copolymer (2) containing predominantly units derived from the methyl methacrylate monomer is formed from 80 to 99%, by weight of methyl methacrylate units and from 1 to 20%, by weight of units derived from monoethylenically unsaturated comonomers copolymerizable with methyl methacrylate.

23. Moulded discs according to claim 21, characterized in that the monoethylenically unsaturated comonomer or comonomers is/are chosen from acrylic, methacrylic, maleimide, maleic anhydride and styrene monomers.

24. Moulded discs according to claim 18, characterized in that the thermoplastic resin (a) is a blend (3) comprising, by weight, 60 to 97%, of a methyl methacrylate homopolymer (1) and/or of a copolymer (2) containing predominantly units derived from the methyl methacrylate monomer, and 3 to 40%, of a substituted or unsubstituted styrene/(meth)acrylonitrile copolymer and/or of a substituted or unsubstituted styrene/maleic anhydride copolymer (SMA) and/or of a substituted or unsubstituted styrene/maleimide copolymer.

25. Moulded discs according to claim 24, characterized in that the thermoplastic resin (a) is a blend (3) comprising, by weight, 70 to 95%, of a methyl methacrylate homopolymer (1) and/or of a copolymer (2) containing predominantly units derived from the methyl methacrylate monomer, and 5 to 30%, of a substituted or unsubstituted styrene/(meth)acrylonitrile copolymer and/or of a substituted or unsubstituted styrene/maleic anhydride copolymer (SMA) and/or of a substituted or unsubstituted styrene/maleimide copolymer.

26. Moulded discs according to claim 24, characterized in that the substituted or unsubstituted styrene/(meth)acrylonitrile copolymer is formed, by weight, from 8 to 35% of (meth)acrylonitrile and from 65 to 92% of substituted or unsubstituted styrene.

27. Moulded discs according to claim 24, characterized in that the substituted or unsubstituted styrene/maleic anhydride copolymer (SMA) is formed, by weight, from 8 to 33% of maleic anhydride and from 67 to 92% of substituted or unsubstituted styrene.

28. Moulded discs according to claim 24, characterized in that the substituted or unsubstituted styrene/maleimide copolymer is formed, by weight, from 8 to 21% of maleimides and from 79 to 92% of substituted or unsubstituted styrene.

29. Moulded discs according to claim 18, characterized in that the thermoplastic resin (a) is a glutarimide polymer (4) comprising imide units of formula: 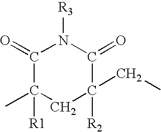
in which the symbols R₁, R₂ and R₃ are identical or different and may be hydrogen or a substituted or unsubstituted alkyl, aryl, alkaryl or aralkyl group having from 1 to 20 carbon atoms, the degree of imidation being at least 40%.

30. Moulded discs according to claim 18, characterized in that the impact modifier compound (b) is a block copolymer comprising at least one elastomer block or a multilayer composite copolymer comprising at least one elastomer layer.

31. Moulded discs according to claim 30, characterized in that the elastomer block of the block copolymer consists of a polymer derived from butadiene, substituted or otherwise, alkyl acrylate or aralkyl acrylate monomers.

32. Moulded discs according to claim 30, characterized in that the elastomer layer of the multilayer composite copolymer is formed by a polymer derived from butadiene, substituted or otherwise, alkyl acrylate or aralkyl acrylate monomers, optionally monoethylenically unsaturated comonomers, or crosslinking and/or grafting monomers.

33. Moulded discs according to claim 18, characterized in that the thermoplastic polymer material is in the form of granules.

34. Moulded discs according to claim 18, characterized in that said moulded discs are obtained by the injection moulding or injection-compression moulding of the thermoplastic polymer material.

35. Moulded discs according to claim 18 comprising at least one moulded disc.

36. Moulded discs according to claim 35, obtained by joining together, by means of an adhesive, two moulded discs, at least one of the moulded discs being metallized.

37. Thermoplastic polymer material characterized in that it comprises, by weight:
(a) from 70 to 85% of a thermoplastic resin chosen from:
(1) a methyl methacrylate homopolymer,
(2) a methyl methacrylate/alkyl acrylate copolymer in which the alkyl group has from 1 to 4 carbon atoms, the amount of alkyl acrylate representing from 0.1 to 3% of the copolymer,
(3) a blend of the homopolymer (1) and/or of the copolymer (2) with a copolymer of a substituted or unsubstituted styrene with at least one monomer chosen from (meth)acrylonitrile, maleic anhydride and maleimides or
(4) a glutarimide polymer, optionally blended with a substituted or unsubstituted styrene/(meth)acrylonitrile copolymer; and
(b) from 15 to 30% of at least one impact modifier compound in the form of particles having an average size of between 10 and 200 nm, preferably between 40 and 150 nm.

38. Process for manufacturing the thermoplastic polymer material according to claim 18 or 37, in the form of granules by melt-blending at least the thermoplastic polymer resin (a) and the impact modifier compound (b).
